(19) United States
(12) Patent Application Publication
(10) Pub. No.: US 2025/0372695 A1
(43) Pub. Date: Dec. 4, 2025

(54) SOLID ELECTROLYTE MEMBRANE

(71) Applicant: FORD GLOBAL TECHNOLOGIES, LLC, Dearborn, MI (US)

(72) Inventors: Zijie LU, Novi, MI (US); Xiaojiang WANG, Saline, MI (US); Wenhui ZHU, Northville, MI (US)

(21) Appl. No.: 18/733,718

(22) Filed: Jun. 4, 2024

(51) Int. Cl. H01M 10/056; H01M 10/0585; H01M 50/403; H01M 50/414; H01M 50/431; H01M 50/443; H01M 50/446; H01M 50/497

(52) U.S. Cl. CPC H01M 10/056; H01M 10/0585; H01M 50/403; H01M 50/414; H01M 50/431; H01M 50/443; H01M 50/446; H01M 50/497; H01M 2300/0068; H01M 2300/0082; H01M 2300/0091

(57) ABSTRACT

A battery component and methods of forming a battery component are presented. The battery component may include a negative electrode assembly, a positive electrode assembly, and a solid electrolyte membrane layered between the negative electrode assembly and the positive electrode assembly. The solid electrolyte membrane has a binder matrix containing sulfide-based solid electrolyte particles with plastic crystal electrolyte particles occupying pores between the sulfide-based solid electrolyte particles.

### TECHNICAL FIELD

The disclosure relates to solid electrolyte membranes.

### BACKGROUND

Solid-state lithium-ion batteries are promising due to their stability and their ability to enable high-energy density anode and cathode materials. However, achieving sufficient ionic conductivity of the solid electrolyte requires high compression levels within the batteries. Electrolyte is mixed with binder to form a separator membrane for the batteries. The separator membrane is then calendered to achieve high densification and ionic conductivity. Despite the calendering, porosity remains in the separator membrane. The presence of empty pores in the solid electrolyte separator reduces the effective ionic conductivity. These pores may also lead to premature mechanical issues by allowing for lithium dendrite growth.

### SUMMARY

In one or more aspects of the disclosure, a battery is presented. The battery includes a negative electrode assembly, a positive electrode assembly, and a solid electrolyte membrane layered between the negative and positive electrode assemblies. The solid electrolyte membrane has a polymeric binder matrix containing sulfide-based solid electrolyte particles and plastic crystal electrolyte particles, where the plastic crystal particles occupy pores between the sulfide-based solid electrolyte particles. The plastic crystal electrolyte particles contain disassociated Li⁺ ions from a lithium-salt and succinonitrile molecules. The lithium-salt may be lithium bis(trifluoromethanesulfonyl)imide. The binder matrix may further include hydrogenated nitrile butadiene rubber. The battery's ionic conductivity can be higher than 0.10 mS/cm or even 0.50 mS/cm, and the ratio of sulfide-based solid electrolyte particles to plastic crystal electrolyte particles can be less than 95:5 or even 80:20. The solid electrolyte membrane thickness is less than 100 μm.

In another aspect of the disclosure, a solid-state battery is presented. The battery has a pair of electrode assemblies and a free-standing solid electrolyte separator with plastic crystal electrolyte particles arranged within a network of sulfide-based solid electrolyte, promoting ion exchange between the electrode assemblies. The plastic crystal electrolyte particles contain dissociated Li⁺ ions from a lithium-salt, such as lithium bis(trifluoromethanesulfonyl)imide, that dissolves in succinonitrile. The free-standing electrolyte separator may further include hydrogenated nitrile butadiene rubber within the network of sulfide-based solid electrolyte particles, and its ionic conductivity can be greater than 0.50 mS/cm.

In yet another aspect of the disclosure, a method of forming a battery component is presented. The method involves dissolving a lithium-salt in a polar solid to disassociate Li⁺ ions and form a plastic crystal electrolyte, mixing the solid electrolyte particles with the plastic crystal electrolyte in a solvent to form a slurry, coating the slurry onto a substrate to form a wet membrane, and drying the wet membrane to form a free-standing solid electrolyte membrane. The method also considers the ratio of solid electrolyte particles to plastic crystal electrolyte particles.

### BRIEF DESCRIPTION OF THE DRAWINGS

FIG. 1 is a diagram showing alignment properties of particles in different states of matter;

FIG. 2 is a molecular diagram of particles of succinonitrile in two different conformations;

FIG. 3 is an image of succinonitrile plastic crystal;

FIG. 4 is a graph of conductivity of lithium-salts as a function of temperature;

FIG. 5 is a schematic diagram of a conventional solid electrolyte separator;

FIG. 6 is a schematic diagram of a solid electrolyte membrane according to one or more aspects of the disclosure;

FIG. 7 is a schematic diagram of a battery according to one or more aspects of the disclosure;

FIG. 8 is a graph of ionic conductivity of solid electrolyte pellet samples according to one or more aspects of the disclosure;

FIG. 9 is a graph of ionic conductivity of solid electrolyte pellet samples according to one or more aspects of the disclosure;

FIG. 10 is a table of properties of solid electrolyte membrane samples according to one or more aspects of the disclosure;

FIG. 11 is a graph of ionic conductivity as a function of densification for solid electrolyte membrane samples according to one or more aspects of the disclosure;

FIG. 12 is a schematic of a measurement of mechanical flexibility of a solid electrolyte membrane sample being taken;

FIG. 13 is a schematic of measurement of the thickness of a solid electrolyte membrane, a sample being taken;

FIG. 14 is a graph of voltage response of solid electrolyte membrane samples being tested in a Li/Li symmetrical cell; and

FIG. 15 is a flowchart of a method according to one or more aspects of the disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement, manufacturing processes, material properties, and intended functionality of aspects of the disclosure. For example, a stated dimension of “10 mm” should be interpreted as “about 10 mm.” Similarly, when a composition is described as having “a ratio of 95:5” it is to be understood as “about 95:5.”

The disclosure relates to methods and compositions of forming a dense solid electrolyte membrane at low pressure to prevent lithium dendrite formation and achieve high ionic conductivity. The dense solid electrolyte membrane for solid-state lithium-ion batteries according to one or more aspects of the disclosure may be made by combining plastic crystal electrolyte with a solid electrolyte. Plastic crystal is a phase of electrolyte characterized by rotational disorder while maintaining long-range molecular order, when particles are in the transitional phase between solid and liquid. In one aspect of the disclosure, succinonitrile, a polar solid capable of dissociating Li⁺ ions from lithium-salts, is used to form the plastic crystal electrolyte.

In the solid electrolyte membrane, plastic crystal electrolyte fills the spaces between the solid electrolyte particles, for increased cohesion and reduced porosity. A binder may further be used in the solid electrolyte membrane to encapsulate the solid electrolyte particles and plastic crystal electrolyte particle to provide robust mechanical properties and high ionic conductivity. The small size and higher mobility of the plastic crystal electrolyte molecules allow them to preferentially occupy the interstitial spaces between solid electrolyte particles, rather than the same spaces being filled by the binder. This configuration results in the solid electrolyte membrane's minimal porosity, increased mechanical flexibility, and high ionic conductivity, making it suitable for use as a free-standing electrolyte membrane.

In one aspect of the disclosure a method may involve solid electrolyte-plastic crystal electrolyte pellets, produced using a solvent-free process. The method may include pressing the pellets under different pressures to form a dense solid electrolyte membrane. When the pellets are compressed at a low pressure of 5 megapascals, the solid electrolyte membrane formed shows a significant increase in ionic conductivity compared to the electrolyte membranes without the plastic crystal electrolyte. This method may be used in the manufacturing of sheet-formed solid electrolyte membranes by further incorporating specific polymeric binders such as polytetrafluoroethylene through a dry processing.

In another aspect of the disclosure, production of free-standing dense solid electrolyte membranes, having solid electrolyte particles and plastic crystal electrolyte particles, via a wet slurry processing is presented. These solid electrolyte membranes are configured to achieve necessary mechanical strength properties and flexibility requirements by integrating a rubbery binder. The solid electrolyte membranes have higher ionic conductivity than electrolyte membranes made solely of solid electrolyte and reduce the need for a high pressure densification step, which simplifies the manufacturing process.

The solid electrolyte membranes presented facilitate easier manufacturing processes for both the separators and the batteries themselves. The increased flexibility of the solid electrolyte membrane increases interfacial contact between a separator and electrodes, contributing to the overall effectiveness and reliability of the battery systems.

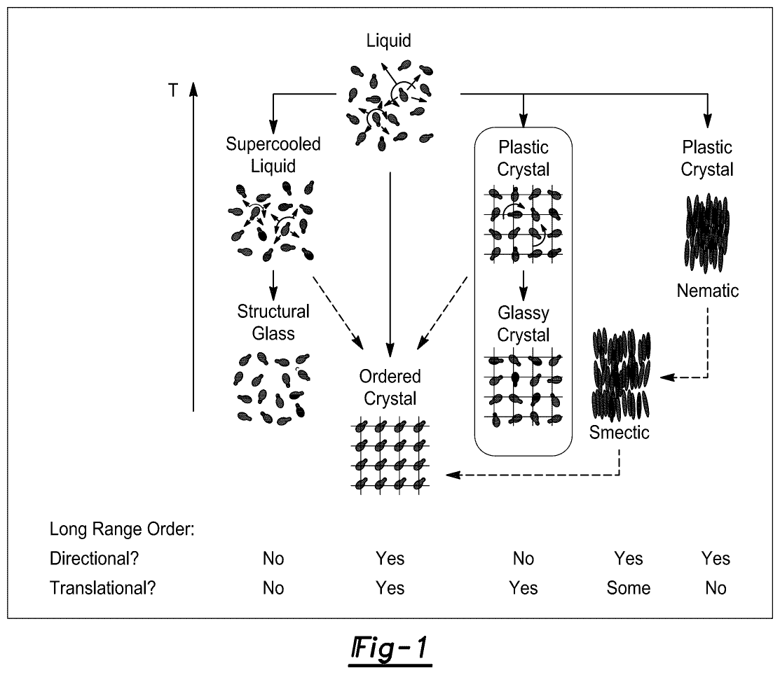

FIG. 1 shows the phase transitions of various materials as temperature (T) changes, showing their molecular structures and order. A liquid state may form a supercooled liquid that transforms into a structural glass with no long-range directional or translational order. Alternatively, a liquid phase may transition directly into an ordered crystal that does exhibit long-range translational order. A liquid may also transition to a liquid crystal having different phases: nematic and smectic. Nematic crystals exhibit long-range directional order without translational order, and smectic crystals exhibit some directional order. Of particular interest to aspects of this disclosure, a liquid phase may transition into a plastic crystal and then to a glassy crystal. Here, the plastic crystal phase maintains translational order but not directional order, having rotational disorder within a structured lattice. This behavior of plastic crystals is particularly relevant as it enables the integration of particles in a plastic crystal phase into interstitial gaps or pores that may be present in a matrix or network of another material.

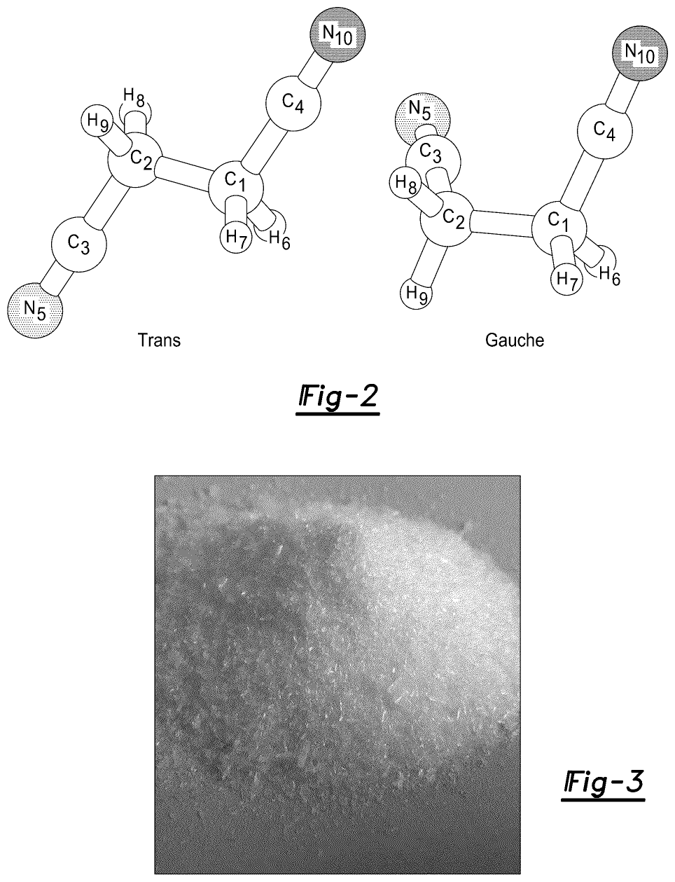

FIG. 2 shows molecular diagrams of particles of succinonitrile in trans and gauche conformations. The balance between these conformations is crucial in the formation of plastic crystal electrolytes, influencing their structural and conductive properties. Trans conformations contribute to the stability and translational order necessary for maintaining the crystal lattice, while gauche conformations allow rotational freedom, enhancing the flexibility and ionic conductivity of the electrolyte. Understanding and manipulating these conformations enable the tailoring of plastic crystal properties to optimize performance in solid-state batteries.

FIG. 3 is a schematic showing the succinonitrile plastic crystal pellet form.

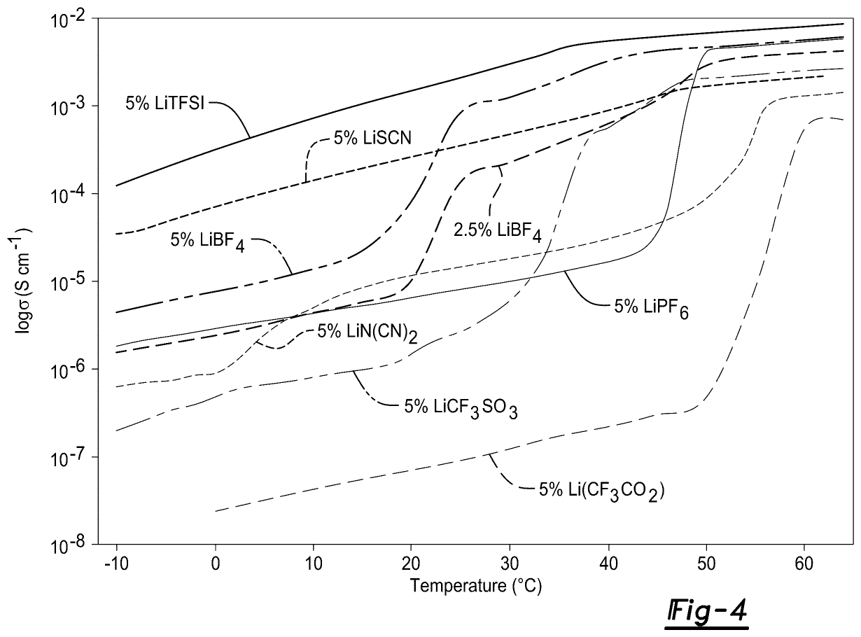

FIG. 4 is a graph cited from Nature Mater., 3, 476 (2004), that shows the conductivity of various succinonitrile-based electrolytes, each formed by dissolving succinonitrile into 5 mol % lithium-salts, across temperatures ranging from −10° C. to 60° C. (Temperature (° C.)). Conductivity values are plotted on a logarithmic scale in siemens per centimeter (S/cm) (log σ(Scm⁻¹)), showing a general increase with rising temperatures. This highlights the temperature-sensitive nature of ionic conductivity in these electrolyte systems.

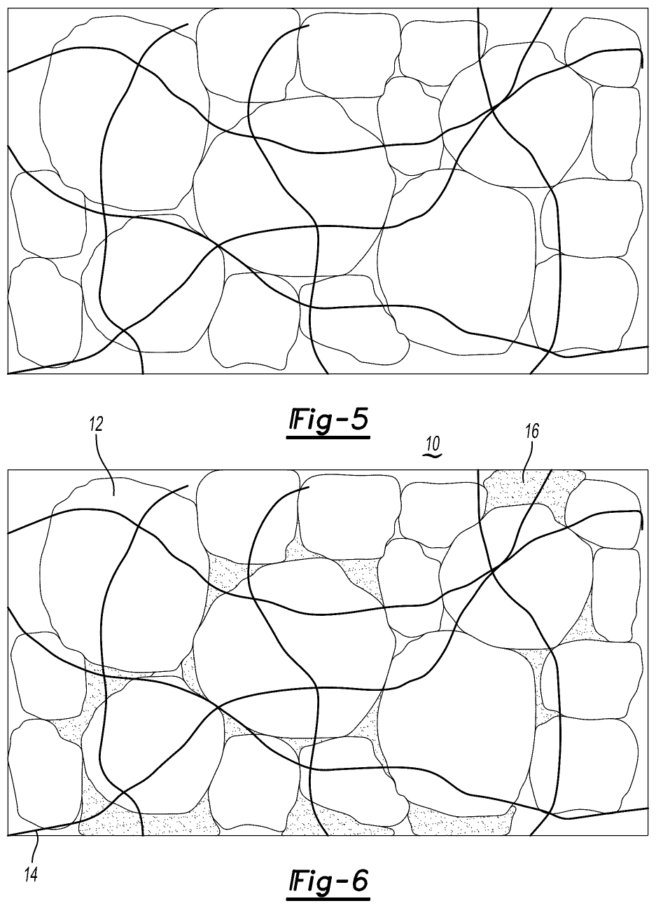

FIG. 5 is a schematic diagram of a conventional solid electrolyte separator. The conventional solid separator contains solid electrolyte particles shown in solid fill and a binder holding the solid electrolyte particles together shown in speckle fill. Noticeable gaps exist between the solid electrolyte particles. These gaps, which are filled by the binder in some instances, reduce the overall conductivity of a battery using the conventional solid electrolyte separator compared to if they had been filled with solid electrolyte particles. These gaps may also allow for lithium dendrite formation during battery cycling, increasing likelihood of short circuits and reducing battery life.

FIG. 6 is a solid electrolyte membrane 10 also referred to as a free-standing electrolyte separator 10 for use in a battery. The membrane 10 has a matrix containing sulfide-based solid electrolyte particles 12, secured by a binder 14, with plastic crystal electrolyte particles 16 occupying the pores or interstitial spaces between the sulfide-based solid electrolyte particles 12. The plastic crystal electrolyte particles 16 contain disassociated Li⁺ ions from a lithium-salt, such as lithium bis(trifluoromethanesulfonyl)imide, and may also contain succinonitrile. The matrix may further include hydrogenated nitrile butadiene rubber. The membrane 10 has a high ionic conductivity, allowing for efficient ion exchange between the electrode assemblies in a battery. The ratio of sulfide-based solid electrolyte particles 12 to plastic crystal electrolyte particles 16 is optimized to ensure good ion conductivity while maintaining the structural integrity of the membrane 10. The thickness of the solid electrolyte membrane 10 is controlled to provide adequate separation between electrode assemblies while minimizing resistance to ion flow.

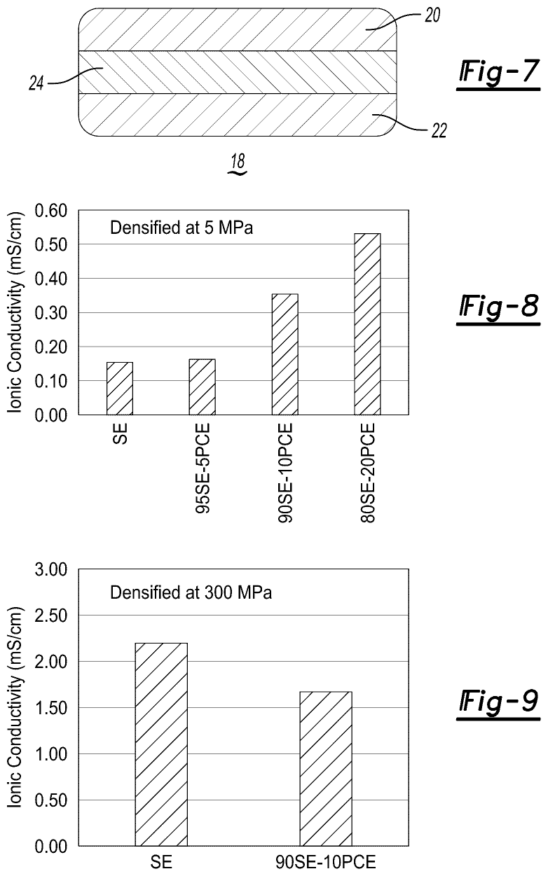

FIG. 7 shows a cross-sectional view of a lithium-ion battery 18 that has a pair of electrode assemblies 20, 22 and a free-standing electrolyte separator 24 positioned between them. The separator 24 plays a role in the battery's performance by allowing efficient ion exchange between the electrode assemblies while preventing direct contact between them. The separator 24 has a matrix containing sulfide-based solid electrolyte particles with plastic crystal electrolyte particles occupying the pores or interstitial spaces between the sulfide-based solid electrolyte particles. This combination of materials enhances the ionic conductivity of the separator 24 while maintaining its structural integrity.

The plastic crystal electrolyte particles contain disassociated Li⁺ ions from a lithium-salt, such as lithium bis(trifluoromethanesulfonyl)imide, and may also contain succinonitrile. The matrix may further include hydrogenated nitrile butadiene rubber, and the solid electrolyte membrane may also include a polymeric binder. The separator 24 has an ionic conductivity higher than 0.10 mS/cm or even 0.50 milliSiemen per centimeter (mS/cm). The ratio of sulfide-based solid electrolyte particles to plastic crystal electrolyte particles in the separator 24 is less than 95:5 or even 80:20, which is optimized to ensure good ionic conductivity while maintaining mechanical strength of the separator. The thickness of the solid electrolyte membrane is less than 100 μm. The electrode assemblies 20, 22 are positioned on either side of the separator 24 and are responsible for the electrochemical reactions that occur during the charging and discharging of the lithium-ion battery 18. The electrode assemblies 20, 22 can be positive or negative electrode assemblies.

FIG. 8 is a graph comparing the ionic conductivity of various solid electrolyte membrane samples that were densified at 5 megapascal (MPa). High porosity is expected to exist in the conventional solid electrolyte pellets at such a low level of densification. The samples include SE (sulfide-based solid electrolyte), 95SE-5PCE (a mixture of 95% sulfide-based solid electrolyte and 5% plastic crystal electrolyte), 90SE-10PCE (a mixture of 90% sulfide-based solid electrolyte and 10% plastic crystal electrolyte), and 80SE-20PCE (a mixture of 80% sulfide-based solid electrolyte and 20% plastic crystal electrolyte). The graph shows that the addition of plastic crystal electrolyte to the sulfide-based solid electrolyte enhances the ionic conductivity, with the 80SE-20PCE sample exhibiting the highest ionic conductivity among the tested samples.

FIG. 9 is a graph comparing the ionic conductivity of two solid electrolyte pellet samples, SE (sulfide-based solid electrolyte) and 90SE-10PCE (a mixture of 90% sulfide-based solid electrolyte and 10% plastic crystal electrolyte), that were densified at 300 MPa. A much higher densification of the electrolyte pellets is expected at this pressure. The graph demonstrates that the 90SE-10PCE sample, which incorporates plastic crystal electrolyte, achieves a high ionic conductivity, about 1.5 mS/cm. This value is slightly lower than that of the pure sulfide-based solid electrolyte (SE) pellet under the same densification conditions. This is understandable because the intrinsic ionic conductivity of the plastic crystal electrolyte (<2 mS/cm) is lower than the intrinsic conductivity of the sulfide solid electrolyte (>2 mS/cm) used in this prototype.

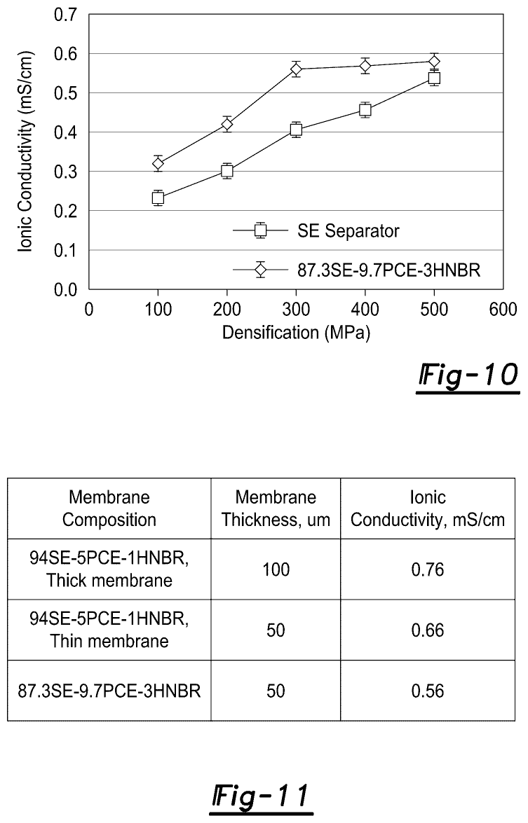

FIG. 10 is a table summarizing the properties of three solid electrolyte membrane samples: 94SE-5PCE-1HNBR (a thick membrane containing 94% sulfide-based solid electrolyte, 5% plastic crystal electrolyte, and 1% hydrogenated nitrile butadiene rubber), 94SE-5PCE-1HNBR (a thin membrane with the same composition), and 87.3SE-9.7PCE-3HNBR (a membrane containing 87.3% sulfide-based solid electrolyte, 9.7% plastic crystal electrolyte, and 3% hydrogenated nitrile butadiene rubber). The table compares the membrane thickness (μm) and ionic conductivity (mS/cm) of these samples, highlighting the relationship of composition and thickness on the ionic conductivity of the solid electrolyte membranes.

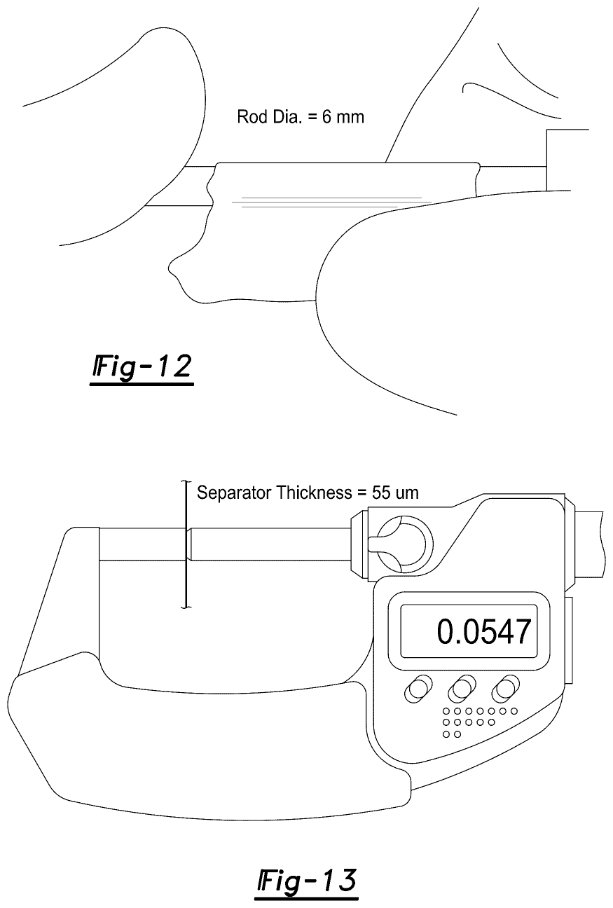

FIG. 11 is a graph illustrating the relationship between ionic conductivity and densification pressure for two solid electrolyte membrane samples: SE (sulfide-based solid electrolyte) and 87.3SE-9.7PCE-3HNBR (a mixture of 87.3% sulfide-based solid electrolyte, 9.7% plastic crystal electrolyte, and 3% hydrogenated nitrile butadiene rubber). The graph demonstrates that the ionic conductivity (mS/cm) of both samples increases with increasing densification pressure (MPa). However, the 87.3SE-9.7PCE-3HNBR sample, which incorporates plastic crystal electrolyte and hydrogenated nitrile butadiene rubber, consistently achieves higher ionic conductivity values compared to the pure sulfide-based solid electrolyte (SE) sample across the tested range of densification pressures. More importantly, the 87.3SE-9.7PCE-3HNBR membrane reaches the highest ionic conductivity at a lower densification pressure than the conventional SE membrane. This implies that the solid electrolyte-plastic crystal electrolyte hybrid membrane alleviates the densification requirement.

FIG. 12 shows a rod being used to measure the mechanical flexibility of a solid electrolyte separator according to one or more aspects of the disclosure. The rod has a diameter of 6 mm, which serves as a reference for determining the flexibility of the separator. The separator's flexibility is a parameter that affects the manufacturability and fit of the separator within a battery cell.

FIG. 13 shows a micrometer measurement of a separator thickness, which is found to be 55 μm. The thickness of the separator plays a significant role in a battery's performance, as it affects the ion exchange between the electrode assemblies. The separator's composition, with plastic crystal particles occupying the interstitial spaces within the sulfide-based solid electrolyte network, contributes to its effectiveness in facilitating ion transport.

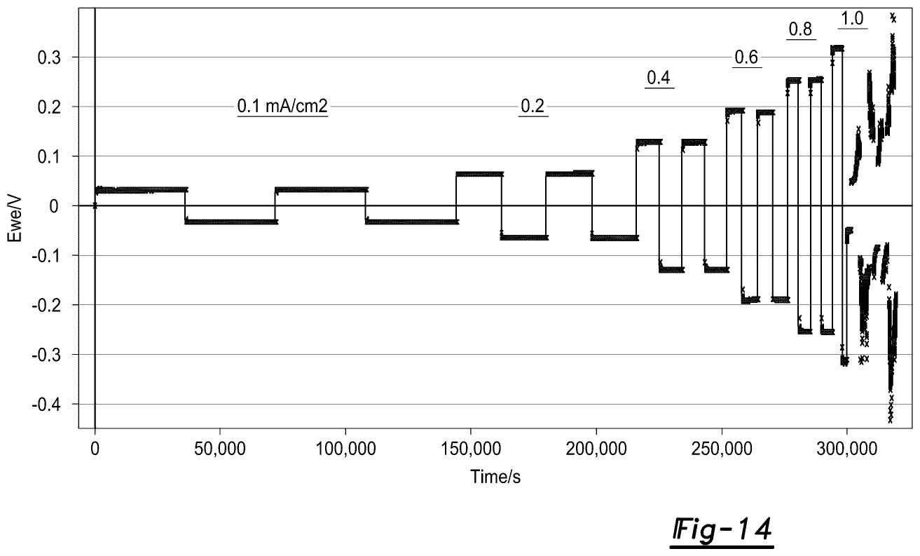

FIG. 14 is a graph of voltage response of a solid electrolyte membrane sample sandwiched in a Li/Li symmetrical cell undergoing through gradually increased current densities from 0.1 to 3.0 mA/cm² milliampere per square centimeter (mA/cm²). The vertical axis represents the working electrode potential (Ewe/V), while the horizontal axis represents the time (Time/s) which indicates the accumulated capacity in each cycle (set to 1 mAh/cm² in this test). The graph demonstrates that the hybrid solid electrolyte membrane is able to support a critical current density of 1.0 mA/cm². This exceptional performance can be attributed to the use of the novel electrolyte separator, which features plastic crystal particles distributed throughout the sulfide electrolyte network.

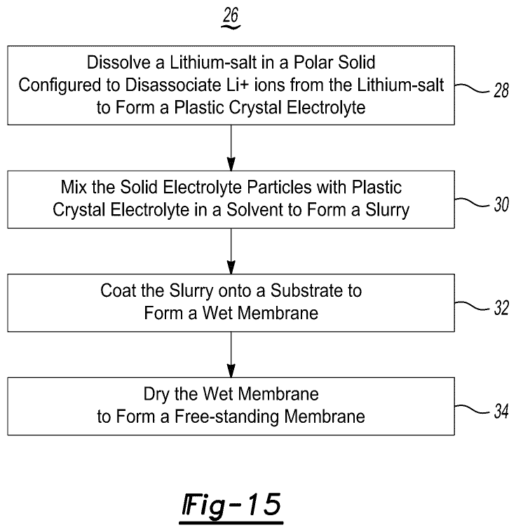

FIG. 15 is a flowchart of a method 26 according to one or more aspects of the disclosure. The method 26 begins with step 28, where a lithium-salt is dissolved in a polar solid configured to disassociate Li⁺ ions from the lithium-salt, resulting in the formation of a plastic crystal electrolyte. In step 30, the solid electrolyte particles are mixed with the plastic crystal electrolyte in a solvent to create a slurry. Step 32 involves coating the slurry onto a substrate to form a wet membrane. Finally, in step 34, the wet membrane is dried to form a free-standing membrane. This method enables the production of a high-performance solid electrolyte separator with a carefully controlled ratio of solid electrolyte particles to plastic crystal electrolyte particles, which is maintained below 95:5 to ensure optimal ion transport and mechanical properties.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A battery comprising:
a negative electrode assembly;
a positive electrode assembly; and
a solid electrolyte membrane, layered between the negative electrode assembly and the positive electrode assembly, with a binder matrix containing sulfide-based solid electrolyte particles with plastic crystal electrolyte particles occupying pores between the sulfide-based solid electrolyte particles.

2. The battery of claim 1 wherein the plastic crystal electrolyte particles contain disassociated Li⁺ ions from a lithium-salt.

3. The battery of claim 2 wherein the lithium-salt is a lithium bis(trifluoromethanesulfonyl)imide.

4. The battery of claim 1 wherein the plastic crystal electrolyte particles contain succinonitrile.

5. The battery of claim 1 wherein the solid electrolyte membrane further includes polymeric binder.

6. The battery of claim 1 wherein the binder matrix further includes hydrogenated nitrile butadiene rubber.

7. The battery of claim 1 wherein ionic conductivity of the solid electrolyte membrane is greater than 0.10 mS/cm.

8. The battery of claim 1 wherein ionic conductivity of the solid electrolyte membrane is greater than 0.50 mS/cm.

9. The battery of claim 1 wherein a ratio of the sulfide-based solid electrolyte particles to the plastic crystal electrolyte particles is less than 95:5.

10. The battery of claim 1 wherein a ratio of the sulfide-based solid electrolyte particles to the plastic crystal electrolyte particles is less than 80:20.

11. The battery of claim 1 wherein a thickness of the solid electrolyte membrane is less than 100 μm.

12. A battery comprising:
a pair of electrode assemblies; and
a free-standing electrolyte separator, having plastic crystal electrolyte particles arranged to occupy interstitial spaces within a network of sulfide-based solid electrolyte, disposed between the pair of electrode assemblies such that the plastic crystal electrolyte particles promote ion exchange between the pair of electrode assemblies.

13. The battery of claim 12 wherein if a lithium metal is used as an electrode, the battery supports a current density no less than 1.0 mA/cm².

14. The battery of claim 12 wherein the plastic crystal electrolyte particles contain dissociated Li⁺ ions from a lithium-salt.

15. The battery of claim 14 wherein the lithium-salt is lithium bis(trifluoromethanesulfonyl)imide.

16. The battery of claim 12 wherein the plastic crystal electrolyte particles contain succinonitrile.

17. The battery of claim 12 wherein the free-standing electrolyte separator further includes hydrogenated nitrile butadiene rubber within the network of sulfide-based solid electrolyte particles.

18. The battery of claim 12 wherein ionic conductivity of the free-standing electrolyte separator is greater than 0.50 mS/cm.

19. A method of forming a battery component comprising:
dissolving a lithium-salt in a polar solid configured to disassociate Li⁺ ions from the lithium-salt to form a plastic crystal electrolyte;
mixing solid electrolyte particles with the plastic crystal electrolyte in a solvent to form a slurry;
coating the slurry onto a substrate to form a wet membrane; and
drying the wet membrane to form a free-standing membrane.

20. The method of claim 19 wherein a ratio of the solid electrolyte particles to particles of the plastic crystal electrolyte is less than 95:5.
